(19) United States
(12) Patent Application Publication
(10) Pub. No.: US 2023/0135334 A1
(43) Pub. Date: May 4, 2023

(54) INFORMATION PROCESSING APPARATUS, COST VALUE CALCULATION METHOD AND COST VALUE CALCULATION PROGRAM

(71) Applicant: Nippon Telegraph and Telephone Corporation, Tokyo (JP)

(72) Inventors: Satoshi TAKATSU, Musashino-shi, Tokyo (JP); Tomoko SHIBATA, Musashino-shi, Tokyo (JP); Hiroshi Yoshida, Musashino-shi, Tokyo (JP)

(21) Appl. No.: 17/913,241

(22) PCT Filed: Apr. 9, 2020
(86) PCT No.: PCT/JP2020/015985

§ 371 Date: Sep. 21, 2022

(51) Int. Cl. G06Q 10/0631; G06Q 30/0201

(52) U.S. Cl. CPC G06Q 10/063112; G06Q 30/0206

(57) ABSTRACT

An information processing device calculates multiple types of assignment cost values for realizing realistic task assignment. The information processing device includes a first assignment cost value calculation unit, a classification unit, and a second assignment cost value calculation unit. The first assignment cost value calculation unit calculates a first assignment cost value by using a first coefficient based on a first restriction in accordance with work skills of workers, on the basis of past task assignment results indicating tasks done by workers on each day. The classification unit classifies the workers based on the past task assignment results. The second assignment cost value calculation unit calculates a second assignment cost value by using a second coefficient based on a second restriction in accordance with classifications of the workers determined by the classification unit, on the basis of the past task assignment results.

### TECHNICAL FIELD

Aspects of the present invention relate to an information processing device, a cost value calculation method, and a cost value calculation program.

### BACKGROUND ART

Deployment of appropriate workers for a plurality of tasks of construction work, product manufacturing, and the like is important in view of safety, production efficiency, and the like.

For example, PTL 1 discloses a scheduling method in which a plurality of evaluation criteria are provided taking into consideration skills of individuals, thereby realizing appropriate deployment of human resources and minimization of the total scheduling time. As the plurality of evaluation criteria, minimization of the total scheduling time, minimization of the number of people to be assigned, and minimization of distribution of assignment time for each person (equalization of assignment time) are used. Also, as an index of the skill of an individual, a past record of processing time spent for each task is used.

### CITATION LIST

### Patent Literature

[PTL 1] Japanese Patent Application Publication 2017-211921

### SUMMARY OF THE INVENTION

### Technical Problem

In the scheduling method of PTL 1, task assignment is made based on one type of assignment cost values, which are skills of individuals, but PTL 1 does not disclose a method for generating the assignment cost values.

Also, in the scheduling method of PTL 1, task assignment is made only based on the above-described one type of assignment cost values, and other types of assignment cost values such as the number and difficulty levels of tasks to be assigned are not taken into consideration. Therefore, the scheduling method of PTL 1 may result in unrealistic task assignment.

The present invention was made in view of the above-described circumstances, and an object thereof is to provide an information processing device, a cost value calculation method, and a cost value calculation program that enable to calculate multiple types of assignment cost values for realizing realistic task assignment.

### Means for Solving the Problem

To solve the above-described problem, according to a first aspect of the present invention, an information processing device includes: a first assignment cost value calculation unit configured to calculate a first assignment cost value by using a first coefficient based on a first restriction in accordance with work skills of workers, on the basis of past task assignment results that indicate tasks done by the workers on each day; a classification unit configured to classify the workers based on the past task assignment results; and a second assignment cost value calculation unit configured to calculate a second assignment cost value by using a second coefficient based on a second restriction in accordance with classifications of the workers determined by the classification unit, on the basis of the past task assignment results.

According to a second aspect of the present invention, a cost value calculation method performed by an information processing device that includes a first assignment cost value calculation unit, a classification unit, and a second assignment cost value calculation unit, and is configured to calculate assignment cost values that are taken as a basis to determine task assignment to workers per day includes the steps of: the first assignment cost value calculation unit calculating a first assignment cost value by using a first coefficient based on a first restriction in accordance with work skills of workers, on the basis of past task assignment results that indicate tasks done by the workers on each day; the classification unit classifying the workers based on the past task assignment results; and the second assignment cost value calculation unit calculating a second assignment cost value by using a second coefficient based on a second restriction in accordance with classifications of the workers determined by the classification unit, on the basis of the past task assignment results.

According to a third aspect of the present invention, a cost value calculation program is executed by a processor of an information processing device that includes the processor and a storage, and causes the processor to function as: a first assignment cost value calculation unit configured to calculate a first assignment cost value by using a first coefficient based on a first restriction in accordance with work skills of workers, on the basis of past task assignment results that indicate tasks done by the workers on each day and are accumulated in the storage; a classification unit configured to classify the workers based on the past task assignment results accumulated in the storage; and a second assignment cost value calculation unit configured to calculate a second assignment cost value by using a second coefficient based on a second restriction in accordance with classifications of the workers determined by the classification unit, on the basis of the past task assignment results accumulated in the storage.

### Effects of the Invention

According to the aspects of the present invention, it is possible to provide an information processing device, a cost value calculation method, and a cost value calculation program that enable to calculate multiple types of assignment cost values for realizing realistic task assignment.

### BRIEF DESCRIPTION OF DRAWINGS

FIG. 1A is a block diagram illustrating an example of a hardware configuration of an information processing device according to an embodiment of the present invention.

FIG. 1B is a block diagram illustrating a software configuration of the information processing device.

FIG. 2 is a diagram illustrating examples of assignment tables accumulated in an assignment table storage unit of the information processing device.

FIG. 3 is a flowchart of operation that is performed by the information processing device.

FIG. 4 is a diagram illustrating an example of a skill table that is stored in a skill table storage unit of the information processing device.

FIG. 5 is a diagram illustrating an example of a task difficulty level table that is stored in a task difficulty level table storage unit of the information processing device.

FIG. 6 is a diagram illustrating an example of a first assignment table, and examples of the skill table, a highest difficulty level task bit table, and a skill label table that are updated based on the first assignment table.

FIG. 7 is a diagram illustrating an example of a second assignment table, and examples of the skill table, the highest difficulty level task bit table, and the skill label table that are updated based on the second assignment table.

FIG. 8 is a diagram illustrating an example of an N-th assignment table, and examples of the skill table, the highest difficulty level task bit table, and the skill label table that are updated based on the N-th assignment table.

FIG. 9 is a diagram illustrating an example of the skill label table updated based on the highest difficulty level task bit table.

FIG. 10 is a diagram illustrating an example of a worker classification table that is generated based on the updated skill label table.

FIG. 11 is a diagram illustrating an example of the first assignment table, and an example of the highest difficulty level task bit table updated based thereon.

FIG. 12 is a diagram illustrating an example of the highest difficulty level task bit table updated based on the second assignment table.

FIG. 13 is a diagram illustrating an example of the N-th assignment table, and an example of the highest difficulty level task bit table updated based thereon.

FIG. 14 is a diagram illustrating an example of a task difficulty level label table generated based on the task difficulty level table.

FIG. 15 is a diagram illustrating an example of a work quality table generated based on the task difficulty level table and the skill table.

FIG. 16 is a diagram illustrating the work quality table, and an example of an assignment table updated based thereon.

FIG. 17 is a diagram illustrating an example of an assignment table that is generated only based on the skill table, as a comparative example.

### DESCRIPTION OF EMBODIMENTS

Hereinafter, an embodiment of the present invention will be described with reference to the drawings.

### (Configuration)

(1) Hardware Configuration

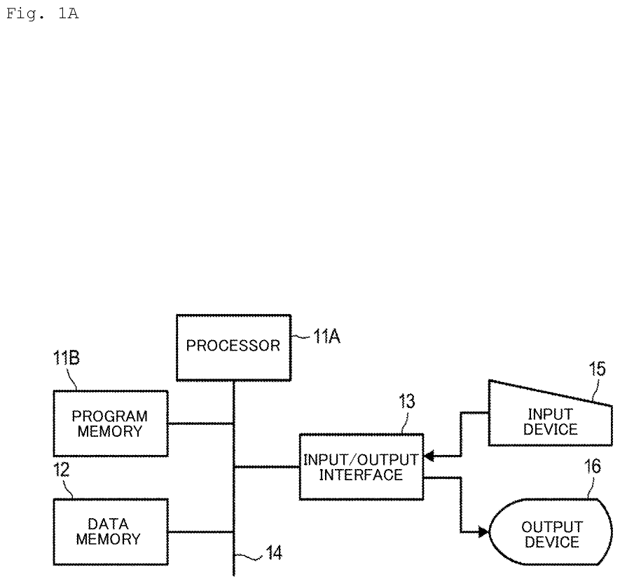

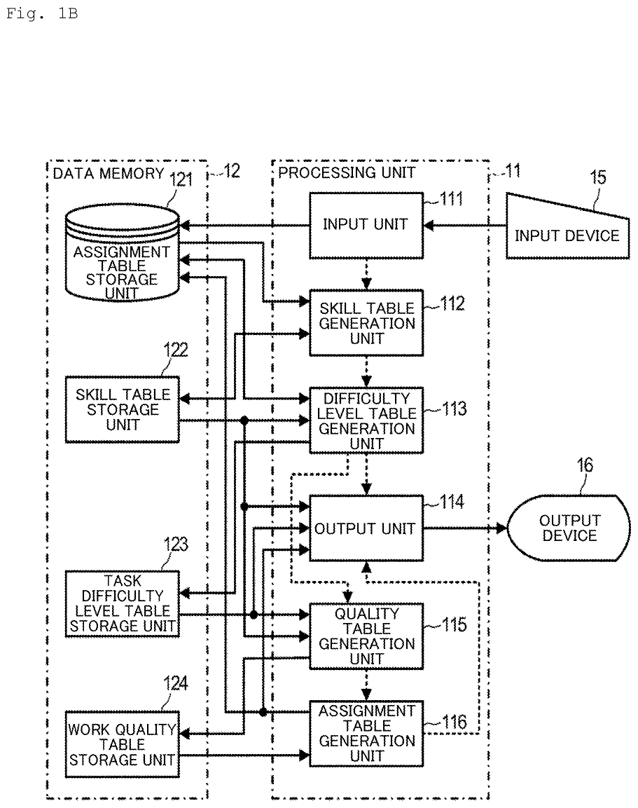

FIG. 1A is a block diagram illustrating an example of a hardware configuration of an information processing device according to an embodiment of the present invention.

The information processing device consists of, for example, a PC (Personal Computer) or the like, and includes a hardware processor 11A such as a CPU (Central Processing Unit) or a MPU (Micro Processing Unit). Also, a program memory 11B, a data memory 12, and an input/output interface 13 are connected to the hardware processor 11A via a bus 14.

The program memory 11B uses, as a storage medium, a combination of, for example, a nonvolatile memory that is freely writable and readable such as an HDD (Hard Disk Drive) or an SSD (Solid State Drive), and a nonvolatile memory such as a ROM (Read Only Memory), and stores a program needed to execute various types of processing.

The data memory 12 is a storage that uses, as a storage medium, a combination of, for example, a nonvolatile memory that is freely writable and readable such as an HDD or an SSD, and a volatile memory such as a RAM (Random Access Memory), and is used to store data obtained and generated while various types of processing are performed.

The input/output interface 13 is an interface with an input device 15 and an output device 16.

The input device 15 includes, for example, a keyboard, a pointing device, and the like that are used by a user to input an instruction to the hardware processor 11A. Also, the input device 15 may include a reader for reading data to be stored in the data memory 12 from a memory medium such as a USB memory, and a disk device for reading such data from a disk medium. The input device 15 may further include an image scanner with or without an OCR (Optical Character Recognition) function.

The output device 16 includes a display for displaying output data that is given from the hardware processor 11A and is to be shown to a user, a printer for printing out the output data, and the like. Also, the output device 16 may include a writer for writing data to be input to another information processing device such as a PC or a smart phone into a memory medium such as a USB memory, and a disk device for writing such data into a disk medium.

Note that the input/output interface 13 may be a wired or wireless communication unit. In this case, the input device 15 and the output device 16 may include an information processing device connected thereto via a wired or wireless network.

(2) Software Configuration

FIG. 1B is a block diagram illustrating a software configuration of the information processing device, in association with the hardware configuration shown in FIG. 1A. Note that in FIG. 1A, dotted arrows indicate the flow of a control signal and solid arrows indicate the flow of data.

The storage area of the data memory 12 includes an assignment table storage unit 121, a skill table storage unit 122, and a task difficulty level table storage unit 123. The storage area of the data memory 12 may also include a work quality table storage unit 124.

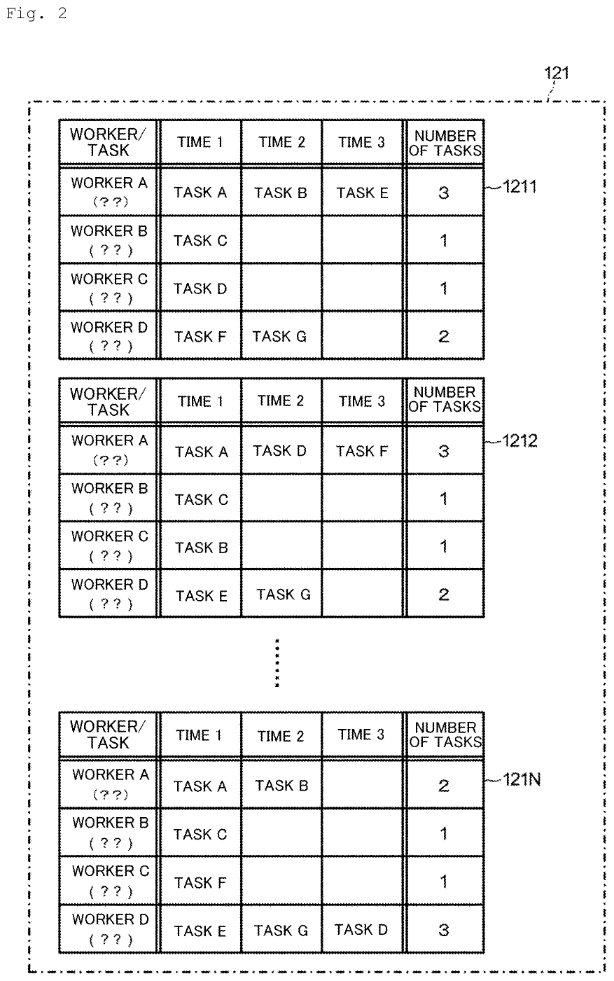

FIG. 2 is a diagram illustrating examples of assignment tables accumulated in the assignment table storage unit 121. The assignment table storage unit 121 accumulates N (where N is an integer of 1 or more) assignment tables 1211, 1212, . . . , 121N. Each of the assignment tables 1211, 1212, . . . , 121N is a table that indicates assignment results of tasks done by workers per day. Therefore, FIG. 2 shows an example in which task assignment results for past N days are accumulated. In the assignment tables 1211, 1212, . . . , 121N, content and the number of tasks done by workers are described. In the assignment tables 1211, 1212, . . . , 121N, “time” does not mean actual time but an index that indicates the order of tasks. Thus, working time spent by a worker A for a task A does not match working time spent by a worker B for a task C in terms of actual time. In terms of actual time, working time spent by the worker A for three tasks A, B, and C corresponds to working time spent by the worker B for the task C.

The skill table storage unit 122 stores a skill table, which is a table in which the number of times each worker has done each task is recorded as a skill value. Also, the skill table storage unit 122 stores a highest difficulty level task bit table, which is a table in which the highest difficulty level task bit indicating whether or not each task is a task with the highest difficulty level is recorded, and a skill label table, which is a table in which the work skills of each worker are recorded. The skill table, the highest difficulty level task bit table, and the skill label table will be described in detail later.

The task difficulty level table storage unit 123 stores a task difficulty level table, which is a table in which the difficulty of each task is recorded. The task difficulty level table will be described in detail later.

The work quality table storage unit 124 stores a work quality table, which is a table in which the work quality of each task achieved by each worker is recorded. The work quality table will be described in detail later.

A processing unit 11 is constituted by the hardware processor 11A and the program memory 11B, and includes, as software-based processing function units, an input unit 111, a skill table generation unit 112, a difficulty level table generation unit 113, and an output unit 114. The processing unit 11 may further include, as software-based processing function units, a quality table generation unit 115 and an assignment table generation unit 116. These processing function units are each realized by causing the hardware processor 11A to execute a program stored in the program memory 11B. The processing unit 11 may also be realized in other various forms that include an integrated circuit such as ASIC (Application Specific Integrated Circuit) or FPGA (field-programmable gate array).

The input unit 111 acquires, via the input/output interface 13, data of the past assignment tables 1211, 1212, . . . , 121N input from the input device 15, and executes processing for storing the acquired data in the assignment table storage unit 121. Alternatively, if the input device 15 is an image scanner, the input unit 111 may have an OCR function and may be configured to acquire, via the input/output interface 13, image data of the past assignment tables input from the input device 15, and convert the acquired image data into data of the assignment tables 1211, 1212, . . . , 121N. Also, the input unit 111 acquires, via the input/output interface 13, a user instruction input from the input device 15, and performs processing in accordance with this user instruction. For example, the input unit 111 may cause the processing function units of the processing unit 11 to execute processing in accordance with an instruction to calculate assignment cost values, or an instruction to generate an assignment table based on the calculated assignment cost value. For example, the input unit 111 outputs a control signal that indicates an instruction input from the input device 15 to the skill table generation unit 112.

Upon receiving the control signal indicating the above-described calculation instruction or generation instruction from the input unit 111, the skill table generation unit 112 reads the past assignment tables 1211, 1212, . . . , 121N stored in the assignment table storage unit 121 one by one. Each time an assignment table is read, the skill table generation unit 112 updates, based on the read assignment table, the skill table, the highest difficulty level task bit table, and the skill label table that are stored in the skill table storage unit 122. Upon completion of processing for all of the assignment tables, the skill table generation unit 112 outputs a control signal indicating the above-described calculation instruction or generation instruction that corresponds to the control signal received from the input unit 111, to the difficulty level table generation unit 113.

Upon receiving the control signal indicating the above-described calculation instruction or generation instruction from the skill table generation unit 112, the difficulty level table generation unit 113 reads the past assignment tables 1211, 1212, . . . , 121N stored in the assignment table storage unit 121 one by one. Each time an assignment table is read, the difficulty level table generation unit 113 updates the task difficulty level table stored in the task difficulty level table storage unit 123 based on the read assignment table and skill labels of the workers indicated by the skill label table stored in the skill table storage unit 122. Then, upon completion of processing for all of the assignment tables, the difficulty level table generation unit 113 outputs, if the control signal received from the skill table generation unit 112 indicates the above-described calculation instruction, a control signal indicating an instruction to output the assignment cost value, to the output unit 114. Also, if the control signal received from the skill table generation unit 112 indicates the above-described generation instruction, the difficulty level table generation unit 113 outputs a control signal that indicates the above-described generation instruction to the quality table generation unit 115.

Upon receiving the control signal indicating the above-described calculation instruction from the difficulty level table generation unit 113, the output unit 114 outputs the skill table stored in the skill table storage unit 122 and the task difficulty level table stored in the task difficulty level table storage unit 123 to the output device 16 via the input/output interface 13.

Upon receiving the control signal indicating the above-described generation instruction from the difficulty level table generation unit 113, the quality table generation unit 115 reads the skill table stored in the skill table storage unit 122 and the task difficulty level table stored in the task difficulty level table storage unit 123, and generates a work quality table based on these tables. For example, the quality table generation unit 115 can generate a work quality table by multiplying the values recorded in the skill table by the values recorded in the task difficulty level table. The quality table generation unit 115 stores the generated work quality table in the work quality table storage unit 124. Then, the quality table generation unit 115 outputs a control signal indicating the above-described generation instruction to the assignment table generation unit 116.

Upon receiving the control signal indicating the above-described generation instruction from the quality table generation unit 115, the assignment table generation unit 116 reads the work quality table stored in the work quality table storage unit 124, and generates a new assignment table based thereon using, for example, the method disclosed in PTL 1 or the like. The assignment table generation unit 116 stores the generated assignment table in the assignment table storage unit 121. Then, the assignment table generation unit 116 outputs a control signal indicating an instruction to output the assignment table, to the output unit 114.

Upon receiving the control signal indicating the above-described output instruction from the assignment table generation unit 116, the output unit 114 outputs the new assignment table stored in the assignment table storage unit 121 to the output device 16 via the input/output interface 13.

Note that the information processing device according to the present embodiment is realized by the hardware processor 11A, which is a computer, and a program stored in advance in the program memory 11B. However, the program can be provided to the information processing device, in the form of being recorded on a non-transitory computer-readable medium or via a network. The program provided in such a manner can be stored in the program memory 11B. Alternatively, a configuration is also possible in which the provided program is stored in the data memory 12, which is a storage, and is executed by the hardware processor 11A as needed, and the hardware processor 11A also serves as the processing unit 11.

(Operation)

For description of processing operation of the information processing device having the above-described configuration, items and preconditions for use in calculating assignment cost values will first be described.

The items for use in calculating assignment cost values include the following items:

(1) the number of assignment, which is the number of tasks to be assigned (assignment target task) (the lower limit “1” and there is no upper limit);

(2) the skill value that indicates the number of times each worker has done each assignment target task (the lower limit “1” and there is no upper limit);

(3) the task difficulty level that indicates the difficulty level of each assignment target task (the lower limit “1” and there is no upper limit); and

(4) the work quality value that indicates the work quality of each worker with respect to each assignment target task (the lower limit “1” and there is no upper limit).

As the desires when tasks are assigned to workers, it is desired that a trainee gets a difficult task thoroughly done and gathers experience, a task with the highest difficulty level is assigned only to an expert for the sake of safety, and the difficulty level is recognized, for example.

In view of the desires, the present embodiment employs the following preconditions:

(1) the case where the number of assignment “0” is not taken into consideration;

(2) there are three classifications of people, namely, “trainee”, “general worker”, and “expert”;

(3) each of the three classifications includes one or more workers;

(4) difficulty levels have three stages, namely, “average”, “difficult”, and “highest difficulty level”;

(5) each of the three stages includes one or more tasks;

(6) a case where total number (of, e.g., tasks)=total number of people (e.g., workers) is excluded;

(7) the number of experts> the number of tasks with the highest difficulty level;

(8) quality should be an objective function;

(9) the number of assignment to a trainee is always one;

(10) a task with the highest difficulty level is assigned to neither a trainee nor a general worker; and

(11) a task with the highest difficulty level is assigned only to an expert, and the number of assignment to an expert is only one.

The following will describe the processing operation of the information processing device of the embodiment under the above-described items and preconditions for use in calculating assignment cost values.

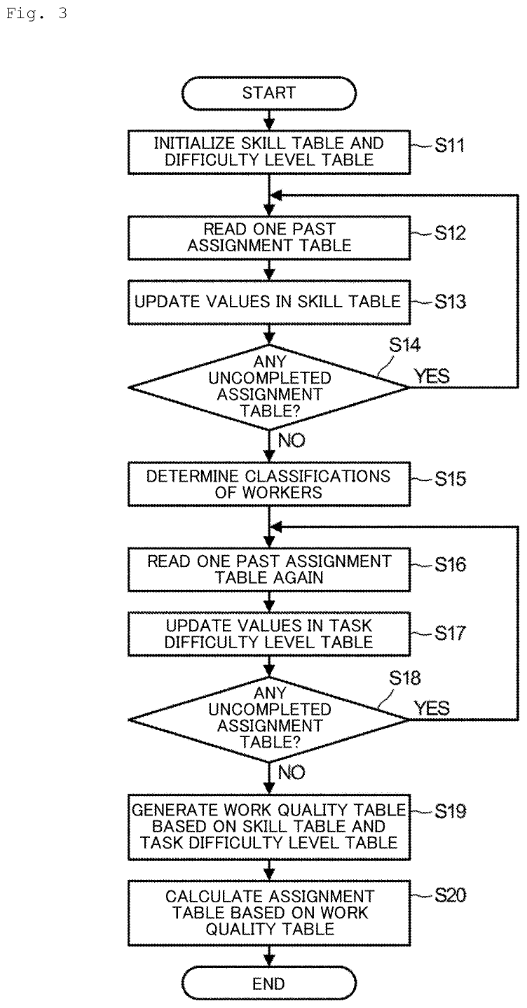

FIG. 3 is a flowchart of the operation that is performed by the information processing device. The processing shown in this operation flowchart indicates an example of the operation that is performed when the input unit 111 receives an instruction to generate an assignment table. A case where the input unit 111 receives an instruction to calculate assignment cost values is not particularly shown in the drawings, but will be described during the description of the operation flowchart.

When the input unit 111 receives an instruction to generate an assignment table, first, all of the assignment cost values in the skill table and the difficulty level table are set to 1 (step S11). That is to say, upon receiving an instruction to generate an assignment table or an instruction to calculate assignment cost values, the input unit 111 transmits a control signal that indicates the generation instruction or the calculation instruction to the skill table generation unit 112. Upon receiving the control signal, the skill table generation unit 112 sets all of the assignment cost values in the skill table to “1”. Then, the skill table generation unit 112 outputs a control signal indicating the above-described generation instruction or calculation instruction to the difficulty level table generation unit 113. Upon receiving the control signal, the difficulty level table generation unit 113 sets all of the assignment cost values in the task difficulty level table to “1”.

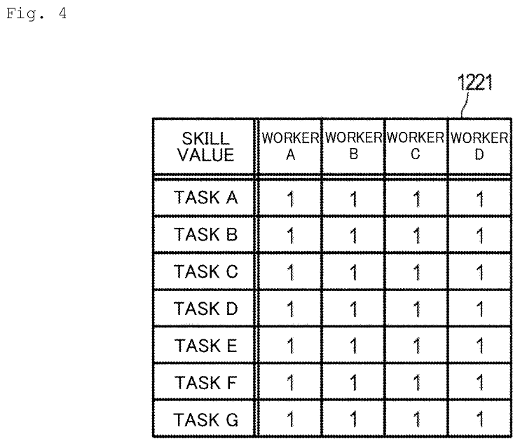

FIG. 4 is a diagram illustrating an example of a skill table 1221 that is stored in the skill table storage unit 122. The skill table 1221 is a table in which skill values are recorded as assignment cost values, each skill value indicating the number of times a worker has done an assignment target task. Here in the skill table 1221, skill values of four workers, namely, workers A to D with respect to seven tasks, namely, tasks A to G are recorded. The skill table generation unit 112 sets, in step S11, all of the skill values in the skill table 1221 stored in the skill table storage unit 122 to “1”, as shown in FIG. 4.

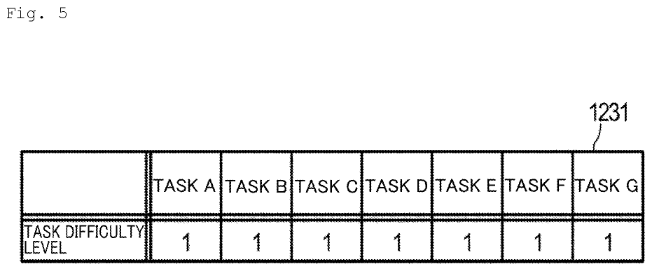

FIG. 5 is a diagram illustrating an example of a task difficulty level table 1231 that is stored in the task difficulty level table storage unit 123. The task difficulty level table 1231 is a table in which task difficulty level values are recorded as assignment cost values, each task difficulty level value indicating the difficulty level of an assignment target task. The larger the task difficulty level value is, the higher the task difficulty level is. The difficulty level table generation unit 113 sets, in step S11, all of the task difficulty level values in the task difficulty level table 1231 stored in the task difficulty level table storage unit 123 to “1”, as shown in FIG. 5.

After the skill table 1221 and the task difficulty level table 1231 have been initialized in the above-described manner, the skill table generation unit 112 reads one of the past assignment tables 1211, 1212, . . . , 121N stored in the assignment table storage unit 121 (step S12). Then, based on the read assignment table, the skill table generation unit 112 updates the skill table 1221, the highest difficulty level task bit table, and the skill label table that are stored in the skill table storage unit 122 with a suitable coefficient (step S13).

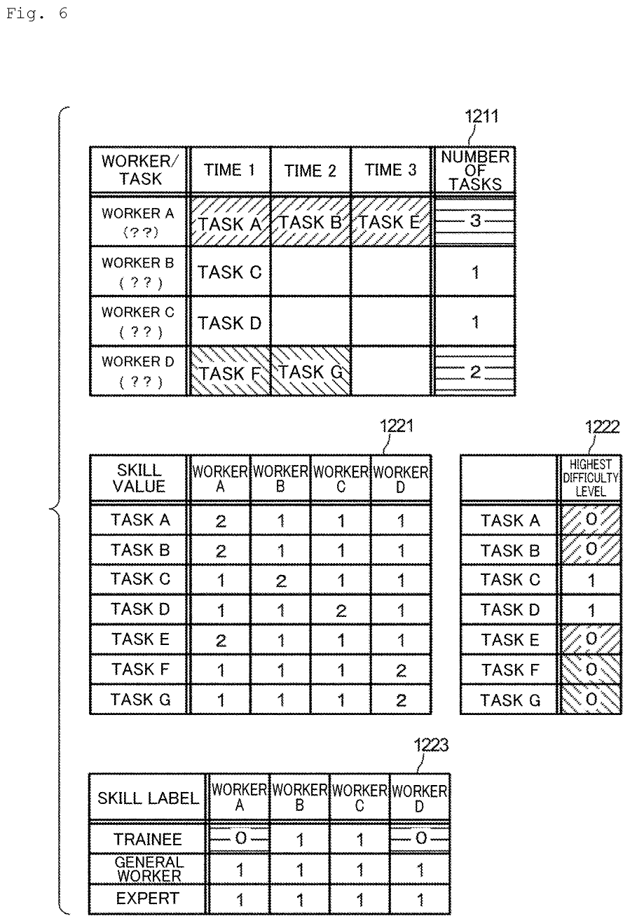

FIG. 6 is a diagram illustrating an example of a first assignment table 1211, and examples of the skill table 1221, a highest difficulty level task bit table 1222, and a skill label table 1223 that are updated based on the first assignment table 1211.

The skill table generation unit 112 regards the tasks assigned to the workers in the assignment table 1211 as having been experienced, and adds “1” to the skill values of the workers in the skill table 1221. Thus, due to the addition of “1”, the skill value of the worker A with respect to the task A, the skill value of the worker A with respect to the task B, the skill value of the worker B with respect to the task C, the skill value of the worker C with respect to the task D, the skill value of the worker A with respect to the task E, the skill value of the worker D with respect to the task F, and the skill value of the worker D with respect to the task G are “2”.

Also, the skill table generation unit 112 generates the highest difficulty level task bit table 1222 and the skill label table 1223 in the skill table storage unit 122, and updates the values in the tables based on the assignment table 1211. Here, the skill table generation unit 112 performs the following operation based on the above-described precondition (9) that the number of assignment to a trainee is always one, and the above-described precondition (11) that a task with the highest difficulty level is assigned only to an expert, and the number of assignment to an expert is only one.

First, the skill table generation unit 112 generates the highest difficulty level task bit table 1222 and the skill label table 1223 in the skill table storage unit 122, and sets all of the values in the tables to bit “1”. Here, the highest difficulty level task bit table 1222 is a table in which highest difficulty level task bits are recorded, each highest difficulty level task bit indicating whether or not the corresponding task is a task with the highest difficulty level. The highest difficulty level task bit value “1” indicates that the corresponding task is a task with the highest difficulty level, and the highest difficulty level task bit value “0” indicates that the corresponding task is not a task with the highest difficulty level. The skill label table 1223 is a table in which the work skills of each worker are recorded. The work skills include three classifications, namely, “trainee”, “general worker”, and “expert”. The bit value “1” indicates that the task falls under the corresponding task skill, and the bit value “0” indicates that the task does not fall under the corresponding task skill.

Then, since the workers to whom two or more tasks, as the number of tasks for each worker, are assigned in the assignment table 1211 are not trainees based on the precondition (9), the skill table generation unit 112 sets the trainee bit values for the corresponding workers in the skill label table 1223 to “0”. In the example of FIG. 6, the worker A for whom the number of tasks in the assignment table 1211 is “3”, and the worker D for whom the number of tasks is “2” are not trainees. Accordingly, the trainee bit values for the worker A and the worker D in the skill label table 1223 are changed from “1” to “0”.

Then, since the two or more tasks that are assigned as the number of tasks for each worker in the assignment table 1211 are not tasks with the highest difficulty level based on the precondition (11), the skill table generation unit 112 sets the bit values for the corresponding tasks in the highest difficulty level task bit table 1222 to “0”. In the example of FIG. 6, the tasks A, B, and E assigned to the worker A for whom the number of tasks “3” is set in the assignment table 1211, and the tasks F and G assigned to the worker D for whom the number of tasks “2” is set are not tasks with the highest difficulty level. Accordingly, the highest difficulty level task bit values for the workers A, B, E, F, and G in the highest difficulty level task bit table 1222 are changed from “1” to “0”.

When the update of the skill table 1221 and the like based on the read assignment table is complete in this manner, the skill table generation unit 112 checks whether or not the processing for all of the past assignment tables 1211, 1212, . . . , 121N stored in the assignment table storage unit 121 is complete (step S14). If there is any uncompleted assignment table, the skill table generation unit 112 returns to step S12, and repeats the above-described processing.

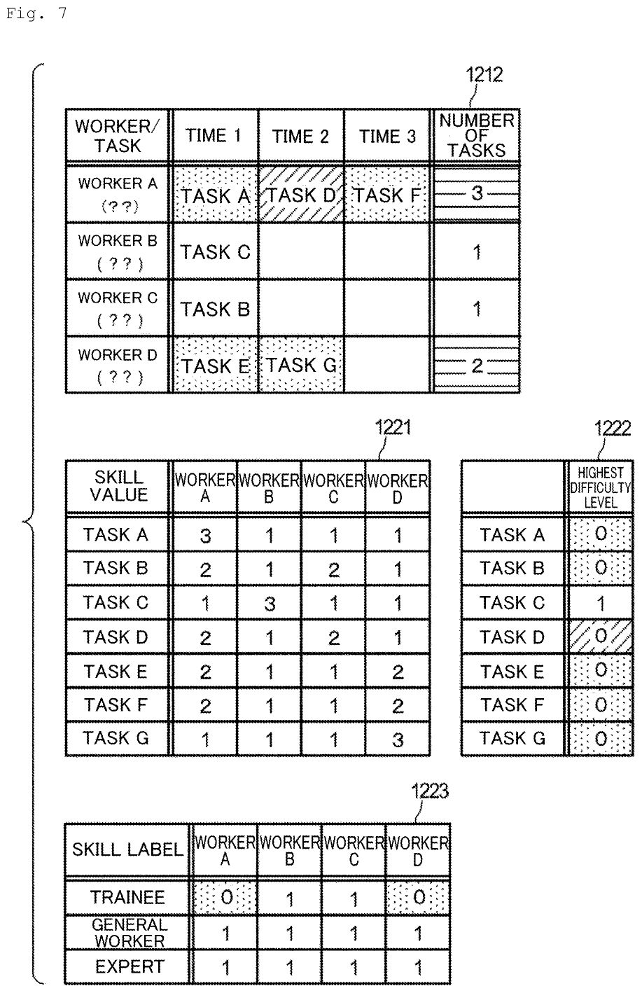

FIG. 7 is a diagram illustrating an example of a second assignment table 1212, and examples of the skill table 1221, the highest difficulty level task bit table 1222, and the skill label table 1223 that are updated based on the second assignment table 1212. With respect to the tasks assigned to the workers in the assignment table 1212, the skill table generation unit 112 adds “1” to the corresponding skill values of the workers in the skill table 1221. Thus, due to the addition of “1”, the skill value of the worker A with respect to the task A, the skill value of the worker B with respect to the task C, and the skill value of the worker D with respect to the task G are “3”. Also, due to the addition of “1”, the skill value of the worker C with respect to the task B, the skill value of the worker A with respect to the task D, the skill value of the worker D with respect to the task E, and the skill value of the worker A with respect to the task F are “2”. Also, the skill table generation unit 112 changes, out of the tasks A, D, and E assigned to the worker A for whom the number of tasks in the assignment table 1212 is “3”, the highest difficulty level task bit value of the task D that has the highest difficulty level task bit value “1” in the highest difficulty level task bit table 1222, to “0”. No change is made in the skill label table 1223.

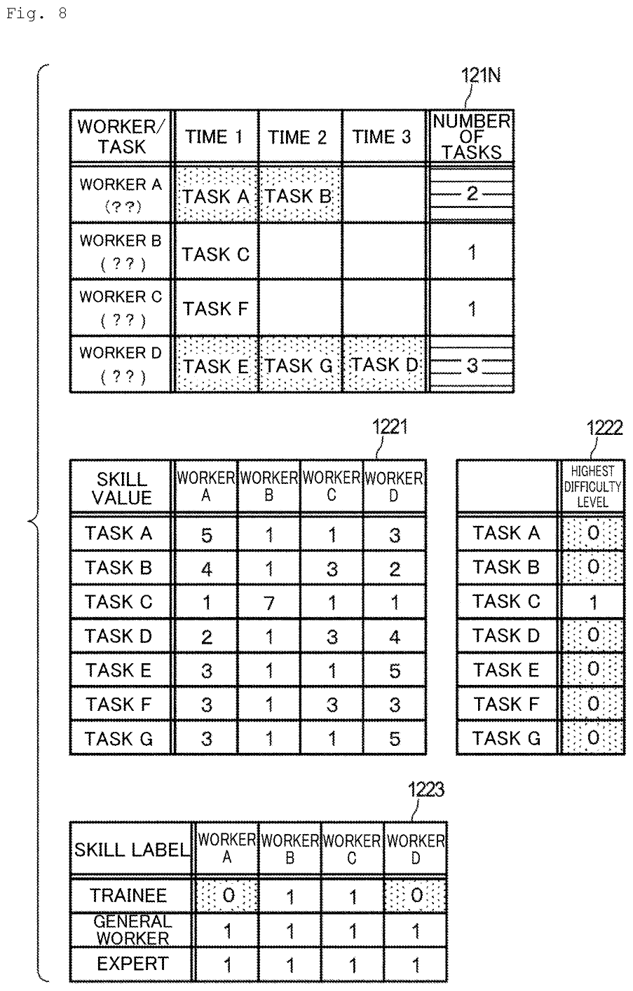

FIG. 8 is a diagram illustrating an example of the N-th (e.g., sixth) assignment table 121N, and examples of the skill table 1221, the highest difficulty level task bit table 1222, and the skill label table 1223 that are updated based on the N-th assignment table 121N. With respect to the tasks assigned to the workers in the assignment table 121N, the skill table generation unit 112 adds “1” to the corresponding skill values of the workers in the skill table 1221. Thus, due to the addition of “1”, the skill value of the worker B with respect to the task C is “7”. Also, due to the addition of “1”, the skill value of the worker A with respect to the task A, the skill value of the worker D with respect to the task E, and the skill value of the worker D with respect to the task G are “5”. Also, due to the addition of “1”, the skill value of the worker A with respect to the task B, and the skill value of the worker D with respect to the task D are “4”. Also, due to the addition of “1”, the skill value of the worker C with respect to the task F is “3”. No change is made in the highest difficulty level task bit table 1222 and the skill label table 1223.

When the processing for all of the past assignment tables 1211, 1212, . . . , 121N stored in the assignment table storage unit 121 is complete in this manner, the skill table generation unit 112 determines NO in step S14. At this point in time, the skill table 1221 and the highest difficulty level task bit table 1222 are complete. However, the skill label table 1223 is not yet complete. Therefore, the skill table generation unit 112 completes the skill label table 1223, and the difficulty level table generation unit 113 determines the classifications of the workers based on the completed skill label table 1223 (step S15).

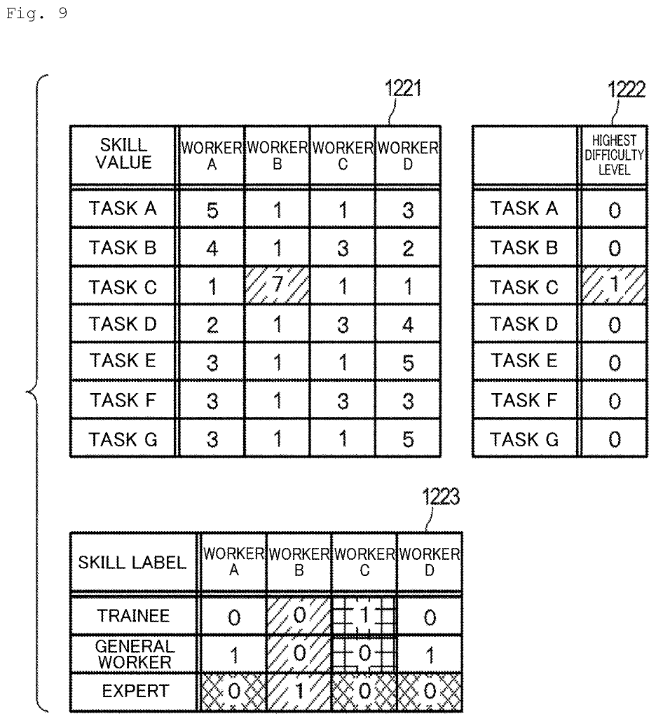

FIG. 9 is a diagram illustrating an example of the skill label table 1223 updated based on the highest difficulty level task bit table 1222. In the highest difficulty level task bit table 1222, the worker to whom the task with the bit “1” was previously assigned is an “expert”. Therefore, the skill table generation unit 112 specifies a worker whose value in the skill table 1221 is “2” or greater with respect to the task C whose bit in the highest difficulty level task bit table 1222 is “1”. Here, the worker B falls under the above-described worker. The skill table generation unit 112 changes the bit values of the worker B in the skill label table 1223, except for the value for “expert”, from “1” to “0”. Also, the skill table generation unit 112 changes the bit values of the workers (workers A, C, and D) other than that worker (worker B) in the skill label table 1223, with respect to “expert”, from “1” to “0”. Here, it is assumed that a worker who is an expert but has not experienced a task with the highest difficulty level is regarded as a general worker. Also, the skill table generation unit 112 regards the worker (worker C in this example) who has eventually the bit (the bit value “1”) for “trainee” in the skill label table 1223 as a “trainee”, and changes the bit value for “general worker” in the skill label table 1223 from “1” to “0”. Here, the worker is a general worker but is regarded as a trainee because he or she does not yet have an ability to accept two or more tasks.

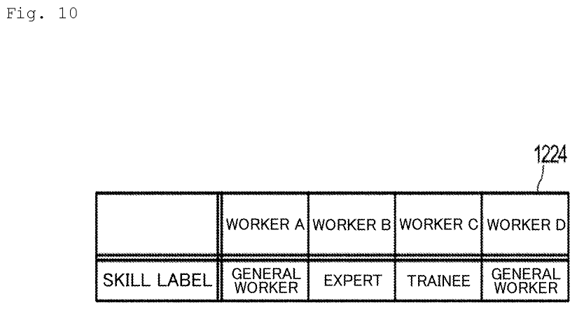

The skill table generation unit 112 may generate, based on the skill label table 1223 thus updated, a worker classification table that indicates the classifications of the workers in the skill table storage unit 122. FIG. 10 is a diagram illustrating an example of such a worker classification table 1224.

Then, the skill table generation unit 112 outputs a control signal indicating an instruction to generate an assignment table or an instruction to calculate assignment cost values to the difficulty level table generation unit 113. Upon receiving the control signal indicating the above-described generation instruction or calculation instruction from the skill table generation unit 112, the difficulty level table generation unit 113 determines the classification, serving as the skill label, of each worker based on the skill label table 1223 or the worker classification table 1224 stored in the skill table storage unit 122. Then, the difficulty level table generation unit 113 reflects the determined classifications on the past assignment tables 1211, 1212, . . . , 121N stored in the assignment table storage unit 121. As shown in FIG. 2 and the like, in the past assignment tables that are input from the input device 15 and stored in the assignment table storage unit 121, the classifications of workers are unknown. Therefore, “??” is given for the classifications of the workers in the assignment tables. The difficulty level table generation unit 113 rewrites “??” for each worker to “trainee”, “general worker”, or “expert”, based on the classifications in the skill label table 1223 or the worker classification table 1224.

Then, the difficulty level table generation unit 113 reads one of the past assignment tables 1211, 1212, . . . , 121N stored in the assignment table storage unit 121 (step S16). The difficulty level table generation unit 113 updates, based on the read assignment table and the skill labels (classifications) of the workers indicated in the skill label table 1223 or the worker classification table 1224 stored in the skill table storage unit 122, the task difficulty level table 1231 stored in the task difficulty level table storage unit 123 with a suitable coefficient (step S17).

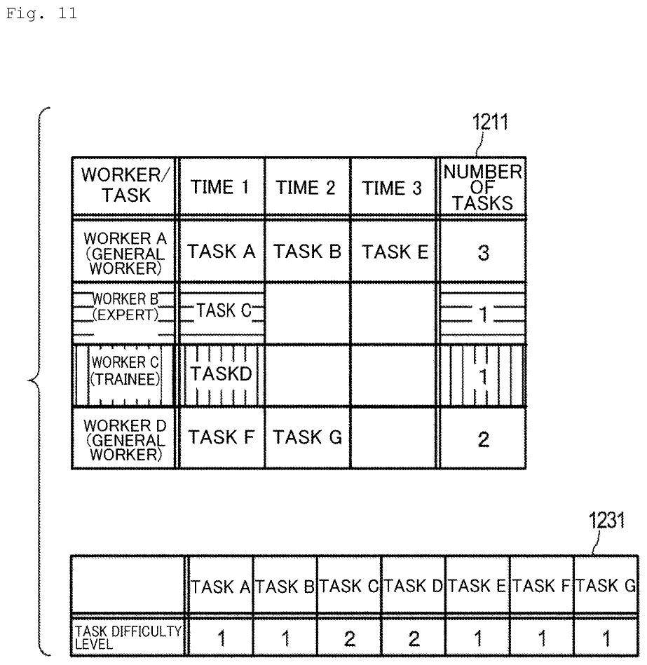

FIG. 11 is a diagram illustrating an example of the first assignment table 1211, and an example of the task difficulty level table 1231 updated based thereon. With respect to the task that is assigned to an “expert” and has the number of tasks “1” in the read past assignment table 1211, the difficulty level table generation unit 113 adds “1” to the corresponding task difficulty level value in the task difficulty level table 1231. Thus, due to the addition of “1”, the task difficulty level value in the task difficulty level table 1231 with respect to the task C assigned to the worker B, who is an “expert”, is “2”. Also, with respect to the task assigned to a “trainee” in the read past assignment table 1211, the difficulty level table generation unit 113 adds “1” to the corresponding task difficulty level value in the task difficulty level table 1231. Thus, due to the addition of “1”, the task difficulty level value in the task difficulty level table 1231 with respect to the task D assigned to the worker C, who is a “trainee”, is “2”.

When the update of the task difficulty level table 1231 based on the read assignment table is complete in this manner, the difficulty level table generation unit 113 checks whether or not the processing for all of the past assignment tables 1211, 1212, . . . , 121N stored in the assignment table storage unit 121 is complete (step S18). If there is any uncompleted assignment table, the difficulty level table generation unit 113 returns to the step S16, and repeats the above-described processing.

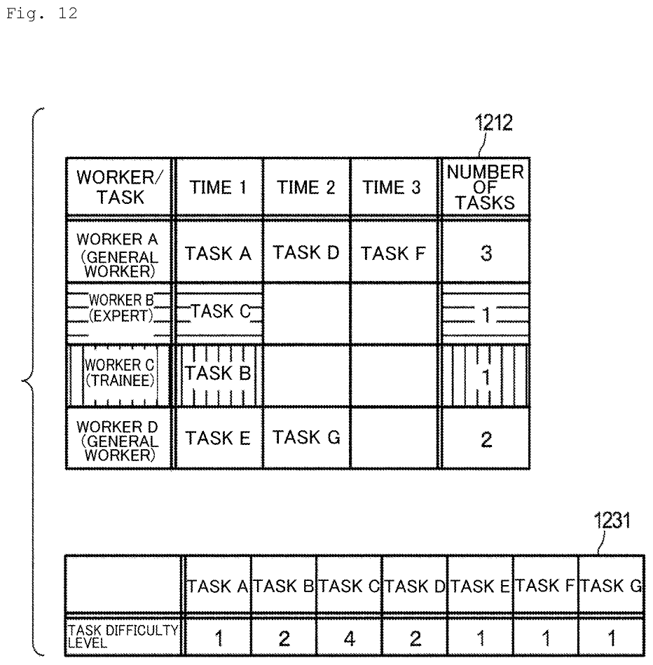

FIG. 12 is a diagram illustrating an example of the task difficulty level table 1231 updated based on the second assignment table 1212. In the case of the above-described first assignment table 1211, the difficulty level table generation unit 113 adds “1” to the task difficulty level value in the task difficulty level table 1231, with respect to a task that is assigned to “expert” and has the number of tasks “1”. In the second assignment tables onwards 1212, . . . , 121N, the difficulty level table generation unit 113 additionally checks whether or not the same task as that of the previous time, that is to say, that of yesterday is assigned. If the same task as that of yesterday is assigned, “2”, instead of “1”, is added to the corresponding task difficulty level value in the task difficulty level table 1231. Thus, due to the addition of “2”, the task difficulty level value in the task difficulty level table 1231 with respect to the task C assigned to the worker B, who is an “expert”, is “4”. Also, with respect to the task assigned to a “trainee” in the read past assignment table 1211, the difficulty level table generation unit 113 adds “1” to the corresponding task difficulty level value in the task difficulty level table 1231. Thus, due to the addition of “1”, the task difficulty level value in the task difficulty level table 1231 with respect to the task B assigned to the worker C, who is a “trainee”, is “2”.

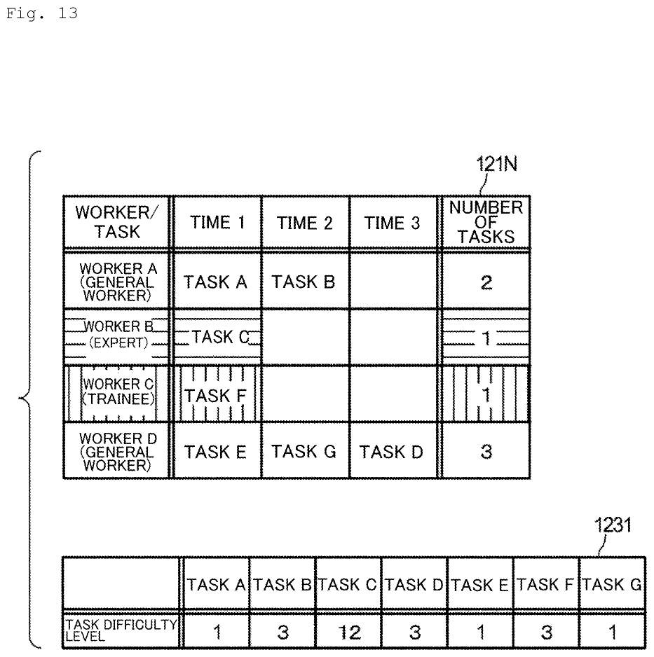

FIG. 13 is a diagram illustrating an example of the N-th assignment table 121N, and an example of the task difficulty level table 1231 updated based thereon. The difficulty level table generation unit 113 adds “1” to the task difficulty level value in the task difficulty level table 1231 with respect to a task that is assigned to an “expert” and has the number of tasks “1”. Alternatively, the difficulty level table generation unit 113 adds “2” to the task difficulty level value in the task difficulty level table 1231 with respect to a task that is assigned to an “expert”, has the number of tasks “1”, and is the same as that of the previous time, that is, that of yesterday. Thus, due to the addition of “2”, the task difficulty level value in the task difficulty level table 1231 with respect to the task C assigned to the worker B, who is an “expert”, is “12”. Also, the difficulty level table generation unit 113 adds “1” to the task difficulty level value in the task difficulty level table 1231 with respect to the task assigned to “trainee” in the read past assignment table 1211. Thus, due to the addition of “1”, the task difficulty level value in the task difficulty level table 1231 with respect to the task F assigned to the worker C, who is a “trainee”, is “3”.

When the processing for all of the past assignment tables 1211, 1212, . . . , 121N stored in the assignment table storage unit 121 is complete in this manner, the difficulty level table generation unit 113 determines NO in step S18.

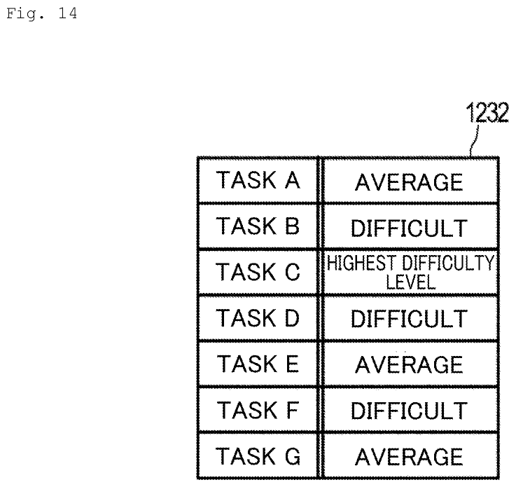

At this time, the difficulty level table generation unit 113 may generate a task difficulty level label table in the task difficulty level table storage unit 123 based on the task difficulty level table 1231, using a suitable threshold set in advance. FIG. 14 is a diagram illustrating an example of a task difficulty level label table 1232 generated based on the task difficulty level table 1231. This example uses the number N of past assignment tables as a threshold for determining whether or not the task is a task with the highest difficulty level, and uses N/4 as a threshold for sorting tasks into difficult tasks and average tasks. That is to say, letting the task difficulty level value in the task difficulty level table 1231 with respect to a task to be subjected to determination be P, if N<P, the difficulty level table generation unit 113 determines that the task is a task with the “highest difficulty level”. If N/4<PN, the difficulty level table generation unit 113 determines that the task is a “difficult” task. If 1<PN/4, the difficulty level table generation unit 113 determines that the task is an “average” task. Thus, the difficulty level table generation unit 113 can label, in addition to a task with the highest difficulty level, a difficult task and an average task.

If NO is determined in step S18, the difficulty level table generation unit 113 outputs, in the case where the instruction received by the input unit 111 from the input device 15 is an instruction to calculate assignment cost values, a control signal indicating an instruction to output the assignment cost value, to the output unit 114, although the processing is not shown. Upon receiving the control signal indicating the above-described output instruction from the difficulty level table generation unit 113, the output unit 114 outputs the skill table 1221 stored in the skill table storage unit 122 and the task difficulty level table 1231 stored in the task difficulty level table storage unit 123 to the output device 16 via the input/output interface 13. Note that, as described above, the skill table 1221 is a table in which skill values are recorded as assignment cost values, each skill value indicating the number of times a worker has done an assignment target task. Also, as described above, the task difficulty level table 1231 is a table in which task difficulty level values are recorded as assignment cost values, each task difficulty level value indicating the difficulty level of an assignment target task.

On the other hand, if the instruction received by the input unit 111 from the input device 15 is an instruction to generate an assignment table, the difficulty level table generation unit 113 outputs a control signal indicating the above-described generation instruction to the quality table generation unit 115. Upon receiving the control signal indicating the above-described generation instruction from the difficulty level table generation unit 113, the quality table generation unit 115 generates a work quality table in the work quality table storage unit 124, based on the skill table 1221 and the task difficulty level table 1231 (step S19).

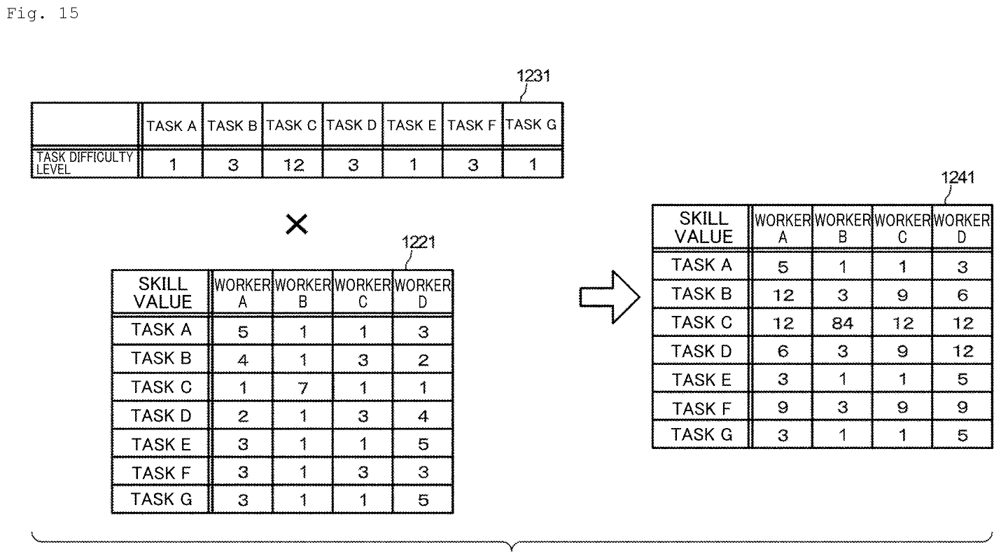

FIG. 15 is a diagram illustrating an example of a work quality table 1241 generated based on the task difficulty level table 1231 and the skill table 1221. The work quality table 1241 is a table in which work quality values are recorded as assignment cost values, each work quality value indicating the work quality of a worker with respect to an assignment target task. Upon receiving the control signal indicating the above-described generation instruction from the difficulty level table generation unit 113, the quality table generation unit 115 reads the skill table 1221 stored in the skill table storage unit 122 and the task difficulty level table 1231 stored in the task difficulty level table storage unit 123. Then, the quality table generation unit 115 generate a work quality table 1241 by multiplying the skill values recorded in the skill table 1221 by the task difficulty level values recorded in the task difficulty level table 1231. That is to say, the quality table generation unit 115 calculates products of the skill values and the task difficulty level values, and records the products in the work quality table 1241. Upon completion of the generation of the work quality table 1241, the quality table generation unit 115 outputs a control signal indicating the above-described generation instruction to the assignment table generation unit 116.

Upon receiving the control signal indicating the above-described generation instruction from the quality table generation unit 115, the assignment table generation unit 116 reads the work quality table 1241 stored in the work quality table storage unit 124, and generates a new assignment table based thereon using, for example, the method disclosed in PTL 1 or the like (step S20).

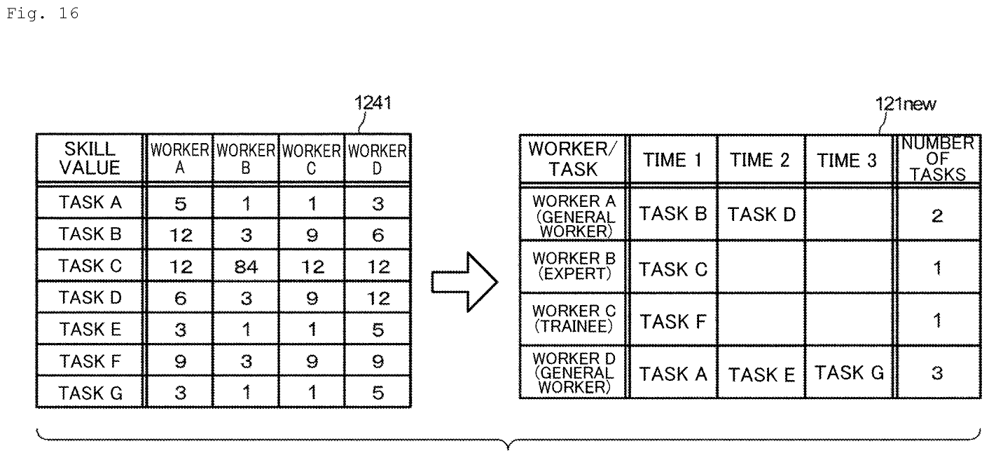

FIG. 16 is a diagram illustrating examples of the work quality table 1241 and an assignment table 121new that is generated based thereon. In this assignment table 121new, only the task C with the “highest difficulty level”, which is a task that can be done per day, is assigned to the worker B, who is an “expert”, and only the “difficult” task F is assigned to the worker C, who is a “trainee”. Also, the “difficult” tasks B and D are assigned to the worker A, who is a “general worker”, and the “average” works A, E, and G are assigned to the worker D, who is also a “general worker”. Thus, by assigning the tasks based on the work quality values that indicate the work quality of the workers with respect to the assignment target tasks and are recorded in the work quality table 1241, task assignment that satisfies the above-described preconditions (9) to (11) is realized. That is to say, since only the task C with the “highest difficulty level” is assigned to the worker B, who is an “expert”, the above-described precondition (11) that “a task with the highest difficulty level is assigned only to an expert, and the number of assignment to an expert is only one” is satisfied. Also, since only the “difficult” task F is assigned to the worker C, who is a “trainee”, the above-described precondition (9) that “the number of assignment to a trainee is always one” is satisfied. Also, since the “difficult” tasks B and D are assigned to the worker A, who is a “general worker”, and the “average” tasks A, E, and G are assigned to the worker D, who is a “general worker”, the above-described precondition (10) that “a task with the highest difficulty level is assigned to neither a trainee nor a general worker” is satisfied.

The assignment table generation unit 116 stores the generated assignment table in the assignment table storage unit 121. Then, the assignment table generation unit 116 outputs a control signal indicating the instruction to output the assignment table, to the output unit 114. Upon receiving the control signal indicating the above-described output instruction from the assignment table generation unit 116, the output unit 114 outputs the new assignment table stored in the assignment table storage unit 121 to the output device 16 via the input/output interface 13.

Note that the work quality values that serve as assignment cost values recorded in the work quality table 1241 and indicate the work quality of the workers with respect to the assignment target tasks are based on the skill values that are recorded in the skill table 1221 and indicate the numbers of times the workers have done the assignment target tasks, and on the difficulty levels of the assignment target tasks that are recorded in the task difficulty level table 1231. Accordingly, step S20 of generating a new assignment table 121new based on the work quality table 1241 can be rephrased as generating a new assignment table 121new based on the skill table 1221 and the task difficulty level table 1231.

Note that if the instruction received by the input unit 111 from the input device 15 is an instruction to calculate assignment cost values, the output unit 114 outputs the skill table 1221 and the task difficulty level table 1231 to the output device 16 via the input/output interface 13. If the output device 16 is another information processing device such as a PC, the processing in steps S19 and S20 can be executed in the output device 16. Also, if the output device 16 is a writer for writing data of the skill table 1221 and the task difficulty level table 1231 into the memory medium, or is a disk device for writing such data into a disk medium, another information processing device such as a PC can read the data from the memory medium or the disk medium, and execute the processing in steps S19 and S20.

(Effects)

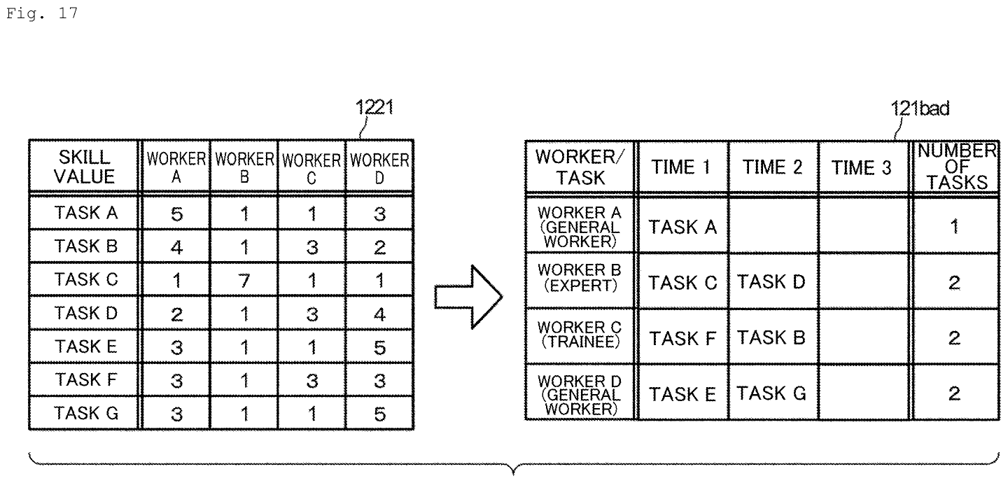

In the scheduling method of PTL 1, tasks are assigned based on assignment cost values, which are skills of individuals. FIG. 17 is a diagram illustrating examples of the skill table 1221 and an assignment table 121bad generated only based thereon, as a comparative example. The skill table 1221 is a table in which skill values are recorded as assignment cost values, each skill value indicating the number of times a worker has done an assignment target task. For example, as shown in FIG. 17, when a new assignment table 121bad is generated based on the assignment cost values recorded in this skill table 1221 using the method disclosed in PTL 1, unrealistic task assignment may be made. That is to say, since assignment costs for the difficulties of assignment target tasks are not taken into consideration, not only the task C with the “highest difficulty level”, which is a task that can be done per day, but also the “difficult” task D may be assigned to the worker B, who is an “expert”. That is to say, the precondition (11) that “a task with the highest difficulty level is assigned only to an expert, and the number of assignment to an expert is only one” cannot be satisfied. Also, two tasks B and F, which are “difficult” tasks, may be assigned to the worker C, who is a “trainee” and to whom only one task can be assigned per day. That is to say, the precondition (9) that “the number of assignment to a trainee is always one” cannot be satisfied.

In contrast, in the information processing device of the present embodiment, tasks are assigned based on multiple types of assignment cost values, namely, skill values each indicating the number of times a worker has done an assignment target task, and difficulty levels of the assignment target tasks, and thus task assignment that satisfies the above-described preconditions (9) to (11) is realized, as shown in FIG. 16.

As described above, the information processing device according to an embodiment includes a skill table generation unit 112 that serves as: a first assignment cost value calculation unit configured to calculate a first assignment cost value by using a first coefficient based on a first restriction in accordance with work skills of workers, on the basis of past task assignment results that indicate tasks done by the workers on each day and are recorded in the assignment tables 1211 to 121N; and a classification unit configured to classify the workers based on the past task assignment results. The information processing device further includes a difficulty level table generation unit 113 that serves as a second assignment cost value calculation unit configured to calculate a second assignment cost value by using a second coefficient based on a second restriction in accordance with classifications of the workers, on the basis of the past task assignment results.

With this, the information processing device can calculate multiple types of assignment cost values for realizing realistic task assignment. Using the multiple types of assignment cost values, it is possible to realize realistic task assignment using, for example, the scheduling method of PTL 1.

Note that the first assignment cost value is a skill value that indicates the number of times each of the workers has done each of assignment target tasks, and the skill table generation unit 112, serving as the first assignment cost value calculation unit, records the calculated skill value in the skill table 1221. Also, the classifications of the workers are label values of at least two grades that indicate the work skills of the workers, such as, for example, “expert”, “general worker”, and “trainee”, and the skill table generation unit 112, serving as the classification unit, records the classification results in the skill label table 1223 or the worker classification table 1224. Also, the second assignment cost value is one of task difficulty level values of at least two grades that indicate difficulty levels of the respective assignment target tasks, and the difficulty level table generation unit 113 serving as the second assignment cost value calculation unit records the calculated task difficulty level value in the task difficulty level table 1231.

With this, the information processing device can calculate, as multiple types of assignment cost values for realizing realistic task assignment, the skill value and the task difficulty level value.

Also, the first restriction in accordance with the work skills of the workers is that a worker with the lowest label value, e.g., a “trainee” worker, of the label values does one task per day, and one task with the highest task difficulty level value, of the task difficulty level values, is done per day only by a worker with the highest label value, e.g., an “expert” worker, of the label values, and the first coefficient based on the first restriction is “+1” with respect to a task that was done. Also, the second restriction in accordance with the classifications of the workers is that a task assignment result of the worker with the lowest label value, of the past task assignment results, is taken as a basis, and a task assignment result only for a task done per day, of the past task assignment results of the worker with the highest label value, is taken as a basis, and the second coefficient on the basis of the second restriction is “+1” with respect to a task that was done by the worker with the lowest label value, is “+1” with respect to a task that was done by the worker with the highest label value and is different from a task done yesterday, and is “+2” with respect to a task that was done by the worker with the highest label value and is the same as a task done yesterday.

With this, by setting the restrictions and coefficients in accordance with the work skills of workers and the classifications of the workers, appropriate cost values are calculated.

Note that the information processing device according to an embodiment further includes an output unit 114 configured to output the first assignment cost value calculated by the skill table generation unit 112 serving as the first assignment cost value calculation unit, and the second assignment cost value calculated by the difficulty level table generation unit 113 serving as the second assignment cost value calculation unit.

With this, the plurality of assignment cost values output from the information processing device can be used by another information processing device, and realistic task assignment can be realized.

Also, the information processing device according to an embodiment further includes the quality table generation unit 115 serving as a third assignment cost value calculation unit configured to calculate, as a third assignment cost value, a work quality value that indicates work quality of each of the workers with respect to each of the assignment target tasks, on the basis of the first assignment cost value calculated by the skill table generation unit 112 serving as the first assignment cost value calculation unit and the second assignment cost value calculated by the difficulty level table generation unit 113 serving as the second assignment cost value calculation unit. The quality table generation unit 115 records the calculated work quality value serving as the third assignment cost value in the work quality table 1241.

By calculating the third assignment cost value based on the first assignment cost value and the second assignment cost value in this manner, it is possible to convert a plurality of assignment cost values into a single assignment cost value, making downstream processing easy.

The information processing device according to an embodiment further includes the assignment table generation unit 116 serving as a task assignment unit configured to assign the assignment target tasks to the workers on the basis of the third assignment cost value calculated by the quality table generation unit 115 serving as the third assignment cost value calculation unit. The assignment table generation unit 116 records the assignment target tasks assigned to the workers in an assignment table 121new.

With this, it is possible to generate the assignment table 121new based on the first assignment cost value and the second assignment cost value. This assignment table 121new can be output by the output unit 114.

Note that the present invention is not limited to the above-described embodiment.

For example, in the embodiment, in step S11, all of the assignment cost values in both the skill table 1221 and the task difficulty level table 1231 are initialized to “1”. However, the assignment cost values in the task difficulty level table 1231 may be initialized after the classifications of the workers are determined in step S15, instead of in step S11.

Also, in the embodiment, as multiple types of assignment cost values for realizing realistic task assignment, the skill table 1221 and the task difficulty level table 1231 are output from the output unit 114 to the output device 16. However, instead of the skill table 1221 and the task difficulty level table 1231, the work quality table 1241, which is obtained by multiplying the assignment cost values of these tables, may be output.

In short, the present invention is not limited to the above-described embodiment as is, and in the implementation stage, various modifications of the constituent components are possible without departing from the spirit of the invention. Also, various inventions can be formed by suitably combining a plurality of constituent components disclosed in the above-described embodiment. For example, some constituent components may be deleted from all of the constituent components described in the embodiment. Furthermore, constituent components that cover different embodiments may be combined with each other as needed.

### REFERENCE SIGNS LIST

11 Processing unit
11A Hardware processor
11B Program memory
12 Data memory
13 Input/output interface
14 Bus
15 Input device
16 Output device
111 Input unit
112 Skill table generation unit
113 Difficulty level table generation unit
114 Output unit
115 Quality table generation unit
116 Assignment table generation unit
121 Assignment table storage unit
1211, 1212, . . . , 121N, 121bad, 121new Assignment table
122 Skill table storage unit
1221 Skill table
1222 Highest difficulty level task bit table
1223 Skill label table
1224 Worker classification table
123 Task difficulty level table storage unit
1231 Task difficulty level table
1232 Task difficulty level label table
124 Work quality table storage unit
1241 Work quality table

1. An information processing device comprising:
a first assignment cost value calculation unit, including one or more processors, configured to calculate a first assignment cost value by using a first coefficient based on a first restriction in accordance with work skills of workers, on the basis of past task assignment results that indicate tasks done by the workers on each day;
a classification unit, including one or more processors, configured to classify the workers based on the past task assignment results; and
a second assignment cost value calculation unit, including one or more processors, configured to calculate a second assignment cost value by using a second coefficient based on a second restriction in accordance with classifications of the workers determined by the classification unit, on the basis of the past task assignment results.

2. The information processing device according to claim 1,
wherein the first assignment cost value is a skill value that indicates the number of times each of the workers has done each of assignment target tasks,
the classifications of the workers are label values of at least two grades that indicate the work skills of the workers, and
the second assignment cost value is one of task difficulty level values of at least two grades that indicate difficulty levels of the respective assignment target tasks.

3. The information processing device according to claim 2,
wherein the first restriction in accordance with the work skills of the workers is that a worker with the lowest label value, of the label values of at least two grades, does one task per day, and one task with the highest task difficulty level value, of the task difficulty level values of at least two grades, is done per day only by a worker with the highest label value, of the label values of at least two grades,
the first coefficient based on the first restriction is “+1” with respect to a task that was done,
the second restriction in accordance with the classifications of the workers is that a task assignment result of the worker with the lowest label value, of the past task assignment results, is taken as a basis, and a task assignment result only for a task done per day, of the past task assignment results of the worker with the highest label value, is taken as a basis, and
the second coefficient based on the second restriction is “+1” with respect to a task that was done by the worker with the lowest label value, is “+1” with respect to a task that was done by the worker with the highest label value and is different from a task done yesterday, and is “+2” with respect to a task that was done by the worker with the highest label value and is the same as a task done yesterday.

4. The information processing device according claim 1, further comprising
an output unit, including one or more processors, configured to output the first assignment cost value calculated by the first assignment cost value calculation unit, and the second assignment cost value calculated by the second assignment cost value calculation unit.

5. The information processing device according to claim 1, further comprising
a third assignment cost value calculation unit, including one or more processors, configured to calculate, as a third assignment cost value, a work quality value that indicates work quality of each of the workers with respect to each of the assignment target tasks, on the basis of the first assignment cost value calculated by the first assignment cost value calculation unit and the second assignment cost value calculated by the second assignment cost value calculation unit.

6. The information processing device according to claim 5, further comprising
a task assignment unit, including one or more processors, configured to assign the assignment target tasks to the workers on the basis of the third assignment cost value calculated by the third assignment cost value calculation unit.

7. A cost value calculation method performed by an information processing device configured to calculate assignment cost values that are taken as a basis to determine task assignment to workers per day, the method comprising:
calculating a first assignment cost value by using a first coefficient based on a first restriction in accordance with work skills of workers, on the basis of past task assignment results that indicate tasks done by the workers on each day;
classifying the workers based on the past task assignment results; and
calculating a second assignment cost value by using a second coefficient based on a second restriction in accordance with classifications of the workers, on the basis of the past task assignment results.

8. A non-transitory computer-readable medium storing a cost value calculation program that is executed by a processor of an information processing device that includes the processor and a storage, the cost value calculation program causing the processor to:
calculate a first assignment cost value by using a first coefficient based on a first restriction in accordance with work skills of workers, on the basis of past task assignment results that indicate tasks done by the workers on each day and are accumulated in the storage;
classify the workers based on the past task assignment results accumulated in the storage; and
calculate a second assignment cost value by using a second coefficient based on a second restriction in accordance with classifications of the workers, on the basis of the past task assignment results accumulated in the storage.

9. The cost value calculation method according to claim 7,
wherein the first assignment cost value is a skill value that indicates the number of times each of the workers has done each of assignment target tasks,
the classifications of the workers are label values of at least two grades that indicate the work skills of the workers, and
the second assignment cost value is one of task difficulty level values of at least two grades that indicate difficulty levels of the respective assignment target tasks.

10. The cost value calculation method according to claim 9,
wherein the first restriction in accordance with the work skills of the workers is that a worker with the lowest label value, of the label values of at least two grades, does one task per day, and one task with the highest task difficulty level value, of the task difficulty level values of at least two grades, is done per day only by a worker with the highest label value, of the label values of at least two grades,
the first coefficient based on the first restriction is “+1” with respect to a task that was done,
the second restriction in accordance with the classifications of the workers is that a task assignment result of the worker with the lowest label value, of the past task assignment results, is taken as a basis, and a task assignment result only for a task done per day, of the past task assignment results of the worker with the highest label value, is taken as a basis, and
the second coefficient based on the second restriction is “+1” with respect to a task that was done by the worker with the lowest label value, is “+1” with respect to a task that was done by the worker with the highest label value and is different from a task done yesterday, and is “+2” with respect to a task that was done by the worker with the highest label value and is the same as a task done yesterday.

11. The cost value calculation method according to claim 7, further comprising
outputting the first assignment cost value, and the second assignment cost value.

12. The cost value calculation method according to claim 7, further comprising
calculating, as a third assignment cost value, a work quality value that indicates work quality of each of the workers with respect to each of the assignment target tasks, on the basis of the first assignment cost value and the second assignment cost value.

13. The cost value calculation method according to claim 12, further comprising
assigning the assignment target tasks to the workers on the basis of the third assignment cost value.

14. The non-transitory computer-readable medium according to claim 8,
wherein the first assignment cost value is a skill value that indicates the number of times each of the workers has done each of assignment target tasks,
the classifications of the workers are label values of at least two grades that indicate the work skills of the workers, and
the second assignment cost value is one of task difficulty level values of at least two grades that indicate difficulty levels of the respective assignment target tasks.

15. The non-transitory computer-readable medium according to claim 14,
wherein the first restriction in accordance with the work skills of the workers is that a worker with the lowest label value, of the label values of at least two grades, does one task per day, and one task with the highest task difficulty level value, of the task difficulty level values of at least two grades, is done per day only by a worker with the highest label value, of the label values of at least two grades,
the first coefficient based on the first restriction is “+1” with respect to a task that was done,
the second restriction in accordance with the classifications of the workers is that a task assignment result of the worker with the lowest label value, of the past task assignment results, is taken as a basis, and a task assignment result only for a task done per day, of the past task assignment results of the worker with the highest label value, is taken as a basis, and
the second coefficient based on the second restriction is “+1” with respect to a task that was done by the worker with the lowest label value, is “+1” with respect to a task that was done by the worker with the highest label value and is different from a task done yesterday, and is “+2” with respect to a task that was done by the worker with the highest label value and is the same as a task done yesterday.

16. The non-transitory computer-readable medium according to claim 8, wherein the cost value calculation program further causes the processors to perform:
outputting the first assignment cost value, and the second assignment cost value.

17. The non-transitory computer-readable medium according to claim 8, wherein the cost value calculation program further causes the processors to perform:
calculating, as a third assignment cost value, a work quality value that indicates work quality of each of the workers with respect to each of the assignment target tasks, on the basis of the first assignment cost value and the second assignment cost value.

18. The non-transitory computer-readable medium according to claim 17, wherein the cost value calculation program further causes the processors to perform:
assigning the assignment target tasks to the workers on the basis of the third assignment cost value.
